(19) United States
(12) Patent Application Publication
(10) Pub. No.: US 2014/0269398 A1
(43) Pub. Date: Sep. 18, 2014

(54) METHOD FOR TRANSMITTING A CQI INDEX FROM A USER TERMINAL

(71) Applicants: Jinsoup Joung, Seongnam-si (KR); Seunghwan Ji, Seongnam-si (KR); Yonghoon Lim, Suwon-si (KR); Eunjin Lee, Seongnam-si (KR)

(72) Inventors: Jinsoup Joung, Seongnam-si (KR); Seunghwan Ji, Seongnam-si (KR); Yonghoon Lim, Suwon-si (KR); Eunjin Lee, Seongnam-si (KR)

(73) Assignee: INNOWIRELESS CO., LTD., Seongnam-si (KR)

(21) Appl. No.: 14/361,486

(22) PCT Filed: Feb. 24, 2012
(86) PCT No.: PCT/KR2012/001422

§ 371 Date: May 29, 2014

(30) Foreign Application Priority Data
Dec. 2, 2011 (KR) 10-2011-0128095

(51) Int. Cl. H04W 24/10

(52) U.S. Cl. CPC H04W 24/10
USPC 370/252

(57) ABSTRACT

A user terminal and a method for transmitting a CQI index from the user terminal to a base station. A method for performing a CQI index conversion so as to have a constant number of bits regardless of the number of bits of a calculated CQI index includes the steps of: calculating the CQI index for a signal received from the base station; converting the calculated CQI index to an one-bit CQI index through delta-sigma modulation; and transmitting the converted one-bit CQI index to the base station.

### TECHNICAL FIELD

The present invention relates to a method for transmitting a CQI index from a user terminal to a base station, and more particularly relates to a method for converting a CQI index to have a constant bit number regardless of a calculated bit number of the CQI index.

### BACKGROUND ART

For a comprehensive power control concept for maximizing the performance in a general wireless communication system, there are various link adaptation methods considering quality of service (QoS). For an example, there are sub-carrier allocation, bit loading, adaptive modulation, power control, and the like. The best way to satisfy QoS for adaptive link is that a base station, which is the operational body performing adaptive link, should accurately comprehend downlink channel status. Thus a method is required for a base station for comprehending downlink channel status as accurately as possible. Feedback method is generally used for such a method, wherein a terminal, which is a main operational body capable of estimating downlink channel status, directly estimates required channel status and transmits the information to the base station. Such information is called as channel quality information (CQI).

In a wireless communication system, a base station periodically receives the channel quality indicator (CQI), which indicates channel status of each individual terminal, from the multiple terminals, and the downlink transmission capability is enhanced by utilizing this (i.e. CQI) and performing adaptive modulation and coding (AMC) or hybrid auto repeat reQuest (HARQ) and the like, thus the overall system capability can be enhanced.

Thus, a shorter reporting period of aforementioned CQI is better in order to promptly reflect the varying channel status of the terminals for a base station. However, in a case where a CQI channel is being used with other channel at the same time, if only the CQI channel is expanded in order to shorten the CQI reporting period, the capacity of the other channel is reduced.

In an OFDM system, in order to optimize sub-carrier allocation, bit loading, adaptive modulation, power control, and the like, it is naturally required to obtain channel information for each sub-carrier. In an LTE system, for example, CQI is managed in a band type wherein many sub-carriers are grouped (sub-band CQI) in order to avoid the complexity of implementation. An LTE system transmits and receives CQI using maximum 4 bits, and the CQI is classified into 16 levels and transmitted by 4 bits.

Thus, the number of bits must be increased by multiple of four in order to simultaneously transmit multiple CQI information on multiple sub-bands.

### SUMMARY OF INVENTION

### Technical Problem

An objective of the present invention for solving the foregoing problem is to provide a method, wherein the number of bits for transmitting the CQI information is equally maintained regardless of the number of bits of the CQI index.

Another objective of the present invention for solving the foregoing problem is to provide a method for reducing overhead in CQI transmission.

### Solution to Problem

To ensure this end, a user terminal of the present invention includes: a CQI index calculation unit for calculating the CQI index for a signal received from the base station; a delta-sigma modulation unit for converting the said CQI index to an one-bit CQI index through delta-sigma modulation; and a communication unit for transmitting the converted one-bit CQI index to said base station.

To ensure this end, a method of the present invention for transmitting a CQI index from a user terminal to a base station includes the steps of: calculating the CQI index for a signal received from the base station; converting the said CQI index to an one-bit CQI index through delta-sigma modulation; and transmitting the converted one-bit CQI index to said base station.

### Advantageous Effects of Invention

A method for transmitting CQI index of the present invention modulates CQI index using a delta-sigma modulation unit, therefore even the number of bits representing the CQI index increases, a user terminal transmits a CQI index to the base station using equal number of bits. Thus by sending CQI index using one bit, there is an effect of reducing the overhead in transmitting CQI.

### BRIEF DESCRIPTION OF DRAWINGS

FIG. 1 illustrates a mobile communication system according to an exemplary embodiment of the present invention;

FIG. 2 illustrates an operation performed in a user terminal according to an exemplary embodiment of the present invention;

FIG. 3 illustrates a configuration of a delta-sigma modulation unit according to an exemplary embodiment of the present invention; and

FIG. 4 is a block diagram illustrating a configuration of a user terminal according to an exemplary embodiment of the present invention.

### DESCRIPTION OF SYMBOLS

| | |
|---|---|
| 100: base station | 110: user terminal |
| 400: communication unit | 402: CQI index calculation unit |
| 404: control unit | 406: delta-sigma modulation unit |

### DESCRIPTION OF EMBODIMENTS

Foregoing and additional features of the present invention will be more apparent through the exemplary embodiments being described with reference to the accompanying drawings. Hereinafter it will be described in detail for a person of ordinary skill in the art can easily understand and implement through these exemplary embodiments of the present invention

FIG. 1 illustrates a mobile communication system according to an exemplary embodiment of the present invention. Hereinafter the element of a mobile communication system according to an exemplary embodiment of the present invention will be investigated in detail.

According to FIG. 1, the mobile communication system includes a user terminal and a base station. Of course it is apparent that another element may further be included except the foregoing elements. For an example, the mobile communication system may further include a base station control unit.

As described above, an LTE system calculates 4 bit CQI having 16 levels. A CQI index has values from 0 to 15; BPSK is used as a modulation method for a zero CQI index, and it is modulated with a high channel coding rate. In addition, as a CQI index increases modulation is performed with a high modulation order and a low channel coding rate. In other words, if the CQI index is 15, 64 QAM is used and the most high channel coding rate is used in signal processing.

The user terminal 110 receives and processes a signal from the base station 100. According to the present invention, the user terminal 110 calculates CQI using the signal-to-noise ratio and the channel gain information of the signal received from the base station 100. In addition, the user terminal 110 verifies whether an error is detected in the signal received from the base station 100. If no error is detected in the received signal, the user terminal 110 creates an ACK signal; if an error is detected, an NACK signal is created. The user terminal 110 transmits the created ACK signal or NACK signal to the base station 100.

Separately from this, the user terminal 110 creates a CQI index for the received signal, and transmits the created CQI index to the base station 100. According to the present invention, the user terminal 110 sets up the ACK signal or the NACK signal transmission period differently from a CQI index transmission period. For an example, while the user terminal 110 transmits the CQI index to the base station with an interval of a first transmission period, the ACK or the NACK signal is transmitted to the base station 100 with an interval of a second transmission period. In other words, the user terminal 110 can transmit the ACK signal or the NACK signal to the base station 100 at the time when it does not transmit the CQI index; the CQI index can be transmitted at the time when it does not transmit the ACK signal or the NACK signal. Of course the user terminal 110 may transmit an ACK signal or an NACK signal with a CQI index at the same time.

The base station 100 determines a modulation method for the signal to be transmitted to the user terminal 110 using the CQI index received from the user terminal 110. In other words, the base station 100 performs modulation with a high modulation order and a low channel coding rate when the received CQI from the user terminal 110 is good; and the modulation is performed with a low modulation order and a high channel coding rate when the received CQI is poor.

In addition, according to the present invention, the base station 100 estimates the channel state of the present base station 100 and the user terminal 110 using the HARQ signal received from the user terminal 110 at the time when the CQI index is not received from the user terminal 110. The HARQ signal includes the above described ACK signal or the NACK signal. In other words, the base station 100 replaces HARQ signal with the CQI index.

In relation with this, when an ACK signal is received from the user terminal 110, the base station 100 presumes that the current channel state is good, and maintains previous CQI index. On the other hand, when an NACK signal is received from the user terminal 110, the base station 100 presumes that the current channel state is poor, and adjusts the previous CQI index. In other words, as explained here in detail, the LTE system creates 4 bit CQI having 16 levels. The CQI index has values from 0 to 15. When an NACK signal is received from the user terminal 110, the base station 100 presumes that the current channel state is poor, and deducts one from the previous CQI index. In other words, if existing index is 10, the base station 100 changes present index to 9 when an NACK signal is received from the user terminal 110, and modulates the signal that is to be transmitted to the user terminal 110 in accordance with the changed index.

FIG. 2 illustrates an operation performed in a user terminal according to an exemplary embodiment of the present invention. Hereinafter, using FIG. 2, the operation performed in a user terminal according to an exemplary embodiment of the present invention will be investigated in detail.

In step S200, the user terminal extracts channel state information. As described above, the user terminal calculates CQI index using the signal received from the base station. The procedures for CQI index calculation is same as explained here in detail.

In step S202, the user terminal performs delta-sigma modulation on the calculated CQI index using the delta-sigma modulation unit. The CQI index is converted into one bit using delta-sigma modulation. Delta-sigma modulation will be explained later.

In step S204, the user terminal transmits the CQI index, which has gone through delta-sigma modulation, to the base station.

FIG. 3 is a drawing of a sigma-delta analog-digital converter according to an exemplary embodiment of the present invention. According to FIG. 3, the sigma-delta analog-digital converter 300 includes a sigma-delta modulator 310 and an accumulator 320.

Said modulator 310, which operates in response to a clock signal CLK, modulates input signal into sigma-delta modulated signal, and outputs the modulated digital output signal. To ensure this end, though it is not shown here, said modulator 310 may include a loop filter, a quantizer for digital signal conversion (not shown here), a DAC, and an adder/subtractor which adds input signal and feedback signal.

Said accumulator 320 receives said digital output signal for accumulation, and outputs an accumulated output value. At this time, said accumulator 320 may accumulate said digital output signal by digital integration thereof, and said accumulated output value may be a digital output value.

Said accumulator 320 may include a first accumulator (1, 2, . . . , N), and if said accumulator 320 includes N number of first accumulators (1, 2, . . . , N), said modulator 11 may also include N number of modulators (or Nth order modulator).

FIG. 4 is a block diagram illustrating a configuration of a user terminal according to an exemplary embodiment of the present invention. Hereinafter, using FIG. 4, the elements of a user terminal according to an exemplary embodiment of the present invention will be investigated in detail.

According to FIG. 4, the user terminal includes a communication unit, a control unit, and a delta-sigma modulation unit. Of course it is apparent that other elements may be included in the base station.

The communication unit 400 transmits a signal to the base station, or receives a signal transmitted from the base station.

The CQI index calculation unit 402 calculates CQI index for the signal received from the base station according to the control instruction of the control unit 404. The procedures for CQI index calculation is same as explained here in detail.

The control unit 404 controls each element comprising the user terminal. For an example, the control unit 404 calculates CQI index for a signal received from the base station by controlling the CQI index calculation unit 402, and performs delta-sigma modulation on the calculated CQI index by controlling the delta-sigma modulation unit 406.

Delta-sigma modulation unit 406 performs delta-sigma modulation on the calculated CQI index by the CQI index calculation unit 402. As explained here in detail, the CQI index has one bit value through the delta-sigma modulation process. The CQI index which has been modulated by the delta-sigma modulation unit 406 is transmitted to the base station through the communication unit as explained here in detail.

Thus, according to the present invention, the user terminal transmits CQI index to the base station using equal number of bits even the number of bits representing the CQI index increases by modulating the CQI index using the delta-sigma modulation unit.

Although the present invention is described with reference to one exemplary embodiment as illustrated in the drawings, it is merely exemplary and it will be understood for the person of ordinary skill in the art that various variations and equivalent other exemplary embodiments are possible from the foregoing disclosure.

What is claimed is:

1. A user terminal characterized in that and includes:
a CQI index calculation unit for calculating a CQI index for a signal received from a base station;
a delta-sigma modulation unit for converting the said CQI index to an one-bit CQI index through delta-sigma modulation; and
a communication unit for transmitting the converted one-bit CQI index to said base station.

2. A user terminal according to claim 1, characterized in that it includes a control unit for instructing said CQI index calculation unit to calculate CQI index, for instructing said delta-sigma modulation unit to perform delta-sigma modulation on said CQI index.

3. A user terminal according to claim 2, characterized in that the CQI index calculated in said CQI index calculation unit is one among the n (n is a natural number) number of CQI indexes, and comprised of m (m is a natural number) bits.

4. A method for transmitting a CQI index from a user terminal to a base station characterized in that and includes the steps of:
a) calculating the CQI index for a signal received from the base station;
b) converting the said CQI index to an one-bit CQI index through delta-sigma modulation; and
c) transmitting the converted one-bit CQI index to said base station.

5. A method for transmitting a CQI index according to claim 4, characterized in that the CQI index calculated in said CQI index calculation unit is one among the n (n is a natural number) number of CQI indexes, and comprised of m (m is a natural number) bits.
